(19) United States
(12) Patent Application Publication
(10) Pub. No.: US 2024/0381121 A1
(43) Pub. Date: Nov. 14, 2024

(54) SIGNALING FOR OPTIMIZED OPERATIONS BETWEEN TERRESTRIAL NETWORKS AND NON-TERRESTRIAL NETWORKS

(71) Applicant: QUALCOMM Incorporated, San Diego, CA (US)

(72) Inventors: Hargovind Prasad BANSAL, Hyderabad (IN); Tom CHIN, San Diego, CA (US); Akash KUMAR, Hyderabad (IN)

(21) Appl. No.: 18/314,749

(22) Filed: May 9, 2023

(51) Int. Cl. H04W 24/02

(52) U.S. Cl. CPC H04W 24/02; H04W 84/06

(57) ABSTRACT

Method and apparatus for a configuration for optimizing operations between TNs and NTNs. The apparatus transmits, to a first network connected to the UE, an indication of a network preference for a second network based on at least an application at the UE. The apparatus communicates with the first network or the second network after sending the indication. The apparatus may switch to the second network automatically in response to transmission of the indication. The apparatus may measure a signal corresponding to the second network to determine a coverage quality of the second network. The apparatus may receive a transition indication to transition to a cell associated with the second network in response to the indication of the network preference for the second network.

### TECHNICAL FIELD

The present disclosure relates generally to communication systems, and more particularly, to a configuration for optimizing operations between terrestrial networks (TNs) and non-terrestrial networks (NTNs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method may include transmitting, to a first network connected to the UE, an indication of a network preference for a second network based on at least an application at the UE. The example method may also include communicating with the first network or the second network after sending the indication.

In another aspect of the disclosure, an apparatus for wireless communication is provided. The apparatus may be a UE that includes a memory and at least one processor coupled to the memory, the memory and the at least one processor configured to transmit, to a first network connected to the UE, an indication of a network preference for a second network based on at least an application at the UE. The memory and the at least one processor may also be configured to communicate with the first network or the second network after sending the indication.

In another aspect of the disclosure, an apparatus for wireless communication at a UE is provided. The apparatus may include means for transmitting, to a first network connected to the UE, an indication of a network preference for a second network based on at least an application at the UE. The example apparatus may also include means for communicating with the first network or the second network after sending the indication.

In another aspect of the disclosure, a non-transitory computer-readable storage medium storing computer executable code for wireless communication at a UE is provided. The code, when executed, by cause a processor to transmit, to a first network connected to the UE, an indication of a network preference for a second network based on at least an application at the UE. The example code, when executed may also cause the processor to communicate with the first network or the second network after sending the indication.

In an aspect of the disclosure, a method of wireless communication at a network entity associated with a first network is provided. The method may include obtaining a first indication from a UE connected to the first network, the first indication indicating a network preference for a second network based on at least an application at the UE. The example method may further include providing a second indication instructing the UE to transition to a cell associated with the second network in response to the first indication.

In another aspect of the disclosure, an apparatus for wireless communication is provided. The apparatus may be a network entity associated with a first network that includes a memory and at least one processor coupled to the memory, the memory and the at least one processor configured to obtain a first indication from a UE connected to the first network, the first indication indicating a network preference for a second network based on at least an application at the UE. The memory and the at least one processor may also be configured to provide a second indication instructing the UE to transition to a cell associated with the second network in response to the first indication.

In another aspect of the disclosure, an apparatus for wireless communication at a network entity associated with a first network is provided. The apparatus may include means for obtaining a first indication from a UE connected to the first network, the first indication indicating a network preference for a second network based on at least an application at the UE. The example apparatus may also include means for providing a second indication instructing the UE to transition to a cell associated with the second network in response to the first indication.

In another aspect of the disclosure, a non-transitory computer-readable storage medium storing computer executable code for wireless communication at a network entity associated with a first network is provided. The code, when executed, may cause a processor to obtain a first indication from a UE connected to the first network, the first indication indicating a network preference for a second network based on at least an application at the UE. The example code, when executed, may also cause the processor to provide a second indication instructing the UE to transition to a cell associated with the second network in response to the first indication.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 shows a diagram illustrating an example disaggregated base station architecture.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and a UE in an access network.

FIG. 5 is a diagram illustrating an example environment that may support wireless communication including aspects of a terrestrial network and a non-terrestrial network (NTN).

FIGS. 6A, 6B, and 6C illustrate example aspects of a network architecture that supports communication via an NTN device.

FIG. 7 is a diagram illustrating an example of a UE assistance information message.

FIG. 8 is a diagram illustrating an example of an NTN UE assistance information message.

FIG. 9 is a call flow diagram of signaling between a UE, a first network, and a second network

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a diagram illustrating an example of a hardware implementation for an example network entity.

### DETAILED DESCRIPTION

In addition to, or as an alternative to a terrestrial network (TN), wireless communication systems, such as a non-terrestrial network (NTN), provide additional network coverage. As an example, an NTN can be provided in regions where TNs are unavailable or have limited coverage. NTNs may also be used for wireless communication in instances where TNs are damaged or non-operational due to inclement weather, natural disasters, or other reasons. NTNs may be deployed in a mixed deployment configurations (e.g., TN+NTN) to handle wireless traffic, even in areas in which a TN is available. The TN+NTN mixed deployment configuration may reduce traffic congestion, improve reachability of a network, and improve user traffic handling capability.

wherein some aspects, a UE that is connected to an NTN may prefer to utilize a TN. For example, one type of network may have benefits for the UE over the other type of network for certain operations or applications, such as but not limited to, voice calls (e.g., voice over NR), robotic-assisted surgery, online classes, video calls, low latency applications, real-time applications, among other examples. Due to latency or real-time constraints, satellite connectivity may introduce an additional propagation delay, which may impact the latency or real-time constraint, and affect the user experience. Aspects presented herein provide for improved handling of UEs by the network in a mixed deployment configurations, such as systems that include TN and NTN components.

Aspects presented herein provide for improved operation between TNs and NTNs. The aspects presented herein may enable a UE to provide, to a first type of network, a network preference for a second type of network. As an example, the UE may indicate the preference to the first network based on use of a particular application at the UE or based on a mode or other condition at the UE. For example, the UE may be communicating via an NTN and may indicate, to the NTN, a preference to communicate via a TN. As another example, the UE may be communicating via the TN and may indicate, to the TN, a preference to communicate via the NTN. The UE may provide the preference in UE assistance information, in some examples. The network may respond by handing the UE over to the other type of network. By the UE providing the preference information to the network, the preference information can assist the network in optimizing load balancing between the TN and NTN nodes, and can improve UE operation via the network.

Although the following description provides examples directed to 5G NR, the concepts described herein may be applicable to other similar areas, such as 6G, 5G-advanced, LTE, LTE-A, CDMA, GSM, xG (where “x” represents a number), and/or other wireless technologies, in which a UE may be configured with a maximal RF operating bandwidth that is reduced compared to other UEs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

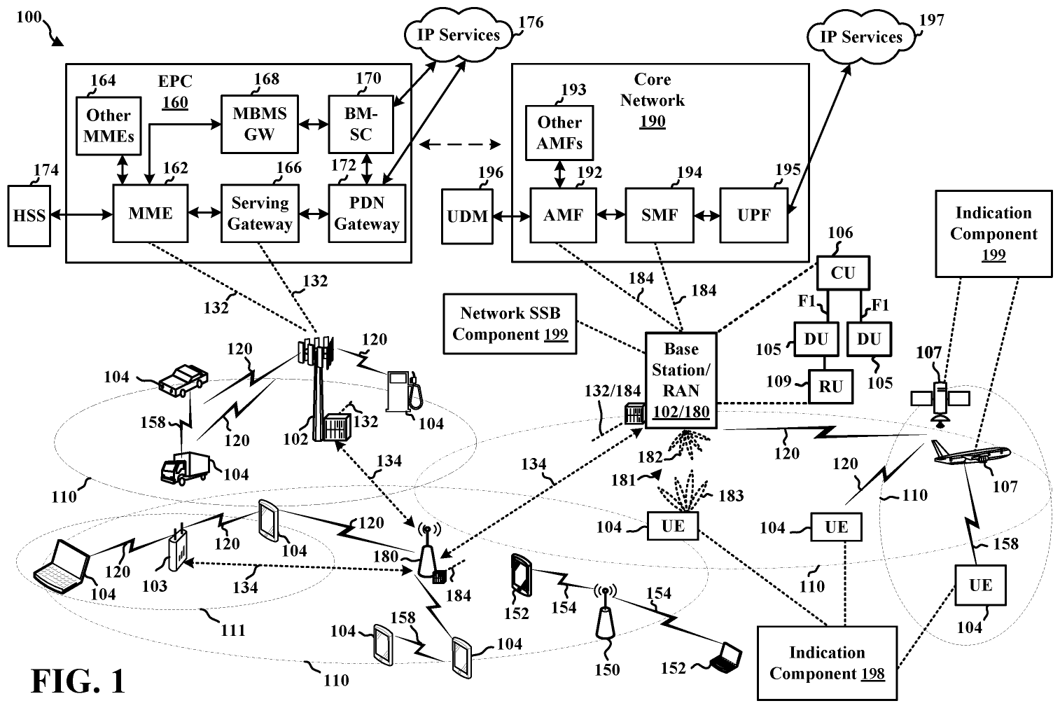

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell 103 may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 103 may operate in a licensed and/or an unlicensed frequency spectrum. When operating in an unlicensed frequency spectrum, the small cell 103 may employ NR and use the same unlicensed frequency spectrum (e.g., 5 GHZ, or the like) as used by the Wi-Fi AP 150. The small cell 103, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 103 or a large cell (e.g., a macro base station), may include and/or be referred to as an eNB, gNodeB (gNB), or another type of base station. Some base stations, such as a gNB, may operate in a traditional sub 6 GHZ spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 181 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 182. The UEs 104 may receive the beamformed signal from the base stations 180 in one or more receive directions 183. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, cNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a wireless device, such as one of the UEs 104, may be in communication with a network entity, such as one of the base stations 102 or a component of a base station (e.g., a CU 106, a DU 105, and/or an RU 109), may be configured to manage one or more aspects of wireless communication. For example, the UEs 104 may include an indication component 198 configured to facilitate transmission of an indication of a network preference based on at least an application at the UE.

In certain aspects, the indication component 198 may be configured to transmit, to a first network connected to the UE, an indication of a network preference for a second network based on at least an application at the UE; and communicate with the first network or the second network after sending the indication.

In another configuration, a network entity, such as an aerial device 107, one of the base stations 102, or a component of a base station (e.g., a CU 106, a DU 105, and/or an RU 109), may be configured to manage or more aspects of wireless communication. For example, the base stations 102 or the aerial device 107 may include an indication component 199 configured to facilitate the transition of a UE to a second network.

In certain aspects, the indication component 199 may be configured to obtain a first indication from a UE connected to the first network, the first indication indicating a network preference for a second network based on at least an application at the UE; and provide a second indication instructing the UE to transition to a cell associated with the second network in response to the first indication.

The aspects presented herein may enable a UE to provide a network preference of a second network based on an application at the UE.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

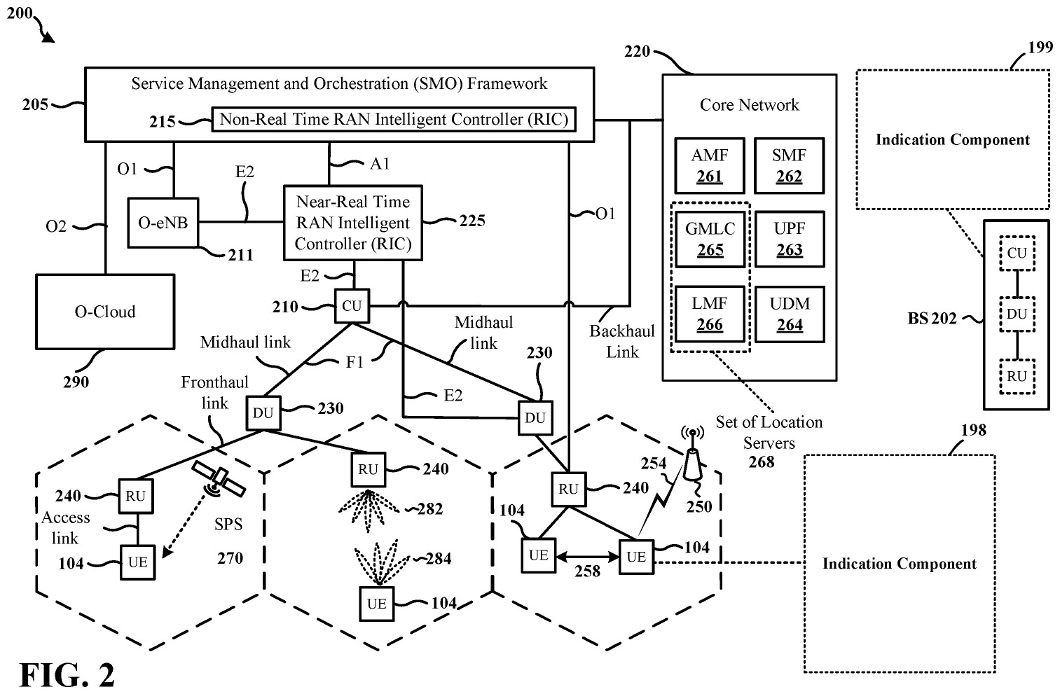

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC 215 associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 104) via one or more radio frequency (RF) access links. In some implementations, the UE 104 may be simultaneously served by multiple RUs. Each of the units, i.e., the CUS (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 104). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface).

Such virtualized network elements can include, but are not limited to, CUs, DUs, RUS and Near-RT RICs. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 104. The communication links between the RUs (e.g., the RU 240) and the UEs (e.g., the UE 104) may include uplink (UL) (also referred to as reverse link) transmissions from a UE 104 to an RU 240 and/or downlink (DL) (also referred to as forward link) transmissions from an RU 240 to a UE 104.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 104 (also referred to as Wi-Fi STAs) via communication link 254, e.g., in a 5 GHz unlicensed frequency spectrum or the like. When communicating in an unlicensed frequency spectrum, the UE 104/Wi-Fi AP 250 may perform a CCA prior to communicating in order to determine whether the channel is available.

The base station 202 and the UE 104 may each include a plurality of antennas, such as antenna elements, antenna panels, and/or antenna arrays to facilitate beamforming. The base station 202 may transmit a beamformed signal 282 to the UE 104 in one or more transmit directions. The UE 104 may receive the beamformed signal from the base station 202 in one or more receive directions. The UE 104 may also transmit a beamformed signal 284 to the base station 202 in one or more transmit directions. The base station 202 may receive the beamformed signal from the UE 104 in one or more receive directions. The base station 202/UE 104 may perform beam training to determine the best receive and transmit directions for each of the base station 202/UE 104. The transmit and receive directions for the base station 202 may or may not be the same. The transmit and receive directions for the UE 104 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UE 104 and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 104 via the AMF 261 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 202 serving the UE 104. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

A wireless device, such as the UE 104, may include the indication component 198 configured to facilitate receiving SSBs for reduced capability UEs in an NTN, as described in connection with the example of FIG. 1.

In certain aspects, a base station, such as the disaggregated base station 200, or component of the base station, may include the indication component 199 configured to facilitate transmitting SSBs for reduced capability UEs in an NTN, as described in connection with the example of FIG. 1.

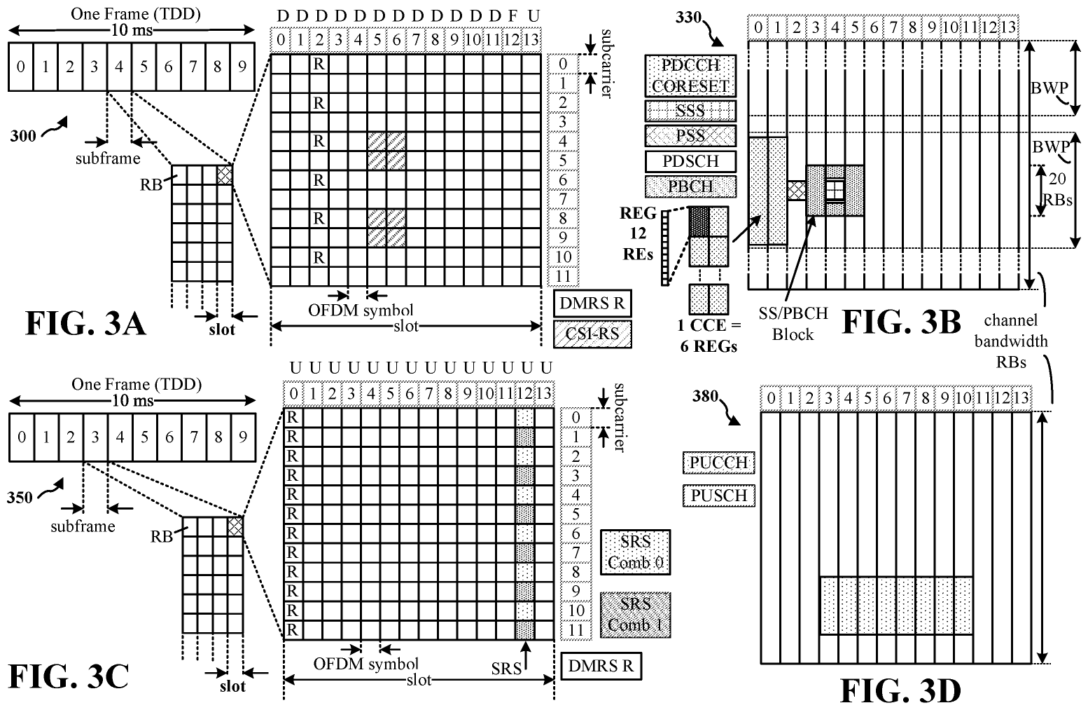

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control 1 information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

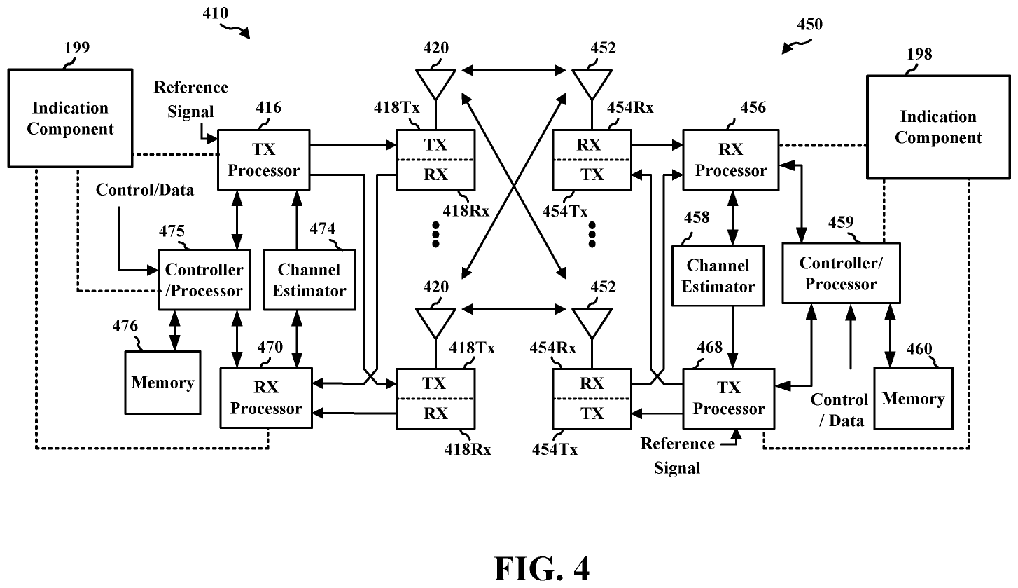

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and memory 476. The example UE 450 includes antennas 452, a transmitter 454Tx, a receiver 454Rx, an RX processor 456, a channel estimator 458, a controller/processor 459, memory 460, and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging. RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the indication component 198 of FIG. 1 and/or FIG. 2.

At least one of the TX processor 416, the RX processor 470, and the controller/processor 475 may be configured to perform aspects in connection with the indication component 199 of FIG. 1 and/or FIG. 2.

As described above, wireless communication systems, such as a NTN, have been introduced to provide ubiquitous network coverage, especially in regions where TNs are unavailable or poor. NTNs may also be used in instances where TNs are damaged or non-operational due to inclement weather, natural disasters, or other reasons. NTNs may be deployed in a mixed deployment configuration (e.g., TN+NTN) to handle traffic, even in TN availability areas. The TN+NTN mixed deployment configuration may reduce traffic congestion, enhance reachability of network, and enhance user traffic handling capability.

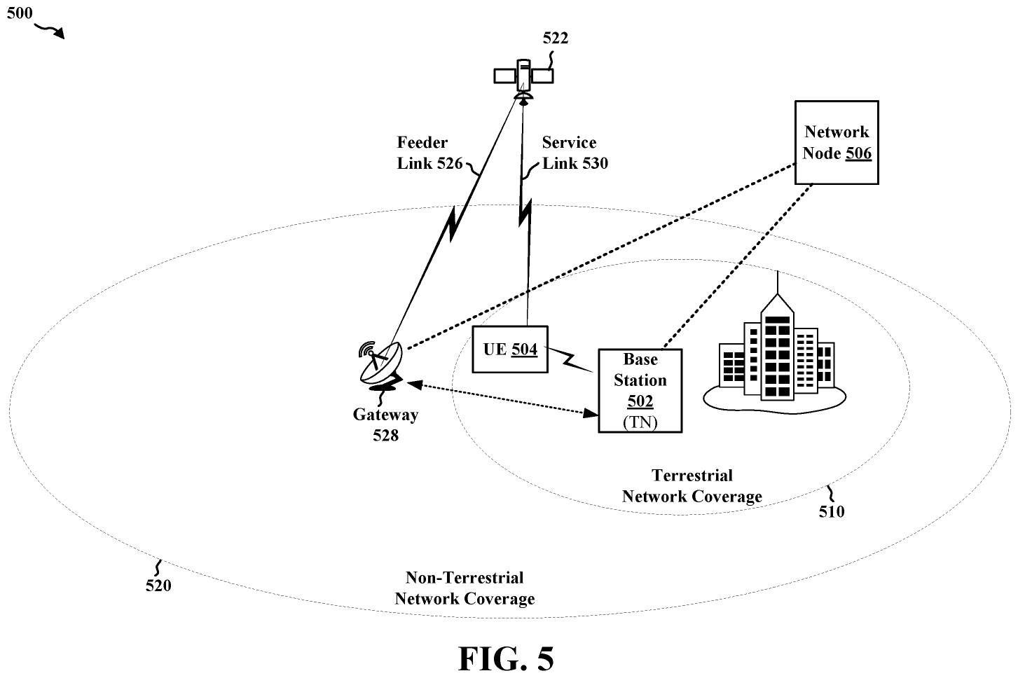

FIG. 5 is a diagram illustrating an example environment 500 that may support wireless communication including aspects of a TN and NTN, as presented herein. To enable communication with a UE, a number of approaches may be utilized.

In some examples, a UE may communicate with a terrestrial network. In the illustrated example of FIG. 5, a TN includes a base station 502 that provides coverage to UEs, such as an example UE 504, located within a coverage area 510 for the TN. The base station 502 may facilitate communication between the UE 504 and a network node 506. Aspects of the network node 506 may be implemented by a core network, such as the example core network 190 of FIG. 1.

In some examples, a UE may transmit or receive communication via a NTN. As an example, the UE may transmit or receive satellite-based communication (e.g., via an Iridium-like satellite communication system or a satellite-based 3GPP NTN). For example, an aerial device 522 may provide coverage to one or more UEs, such as an example UE 504, located within a coverage area 520 for the aerial device 522. In some examples, the aerial device 522 may communicate with the network node 506 through a feeder link 526 established between the aerial device 522 and a gateway 528 in order to provide service to the UE 504 within the coverage area 520 of the aerial device 522 via a service link 530. The UE 504 may be within the coverage area 520 and the coverage area 510. The feeder link 526 may include a wireless link between the aerial device 522 and the gateway 528. The service link 530 may include a wireless link between the aerial device 522 and the UE 504. In some examples, the gateway 528 may communicate directly with the network node 506. In some examples, the gateway 528 may communicate with the network node 506 via the base station 502.

In some aspects, the aerial device 522 may be configured to communicate directly with the gateway 528 via the feeder link 526. The feeder link 526 may include a radio link that provides wireless communication between the aerial device 522 and the gateway 528.

In some aspects, the aerial device 522 may communicate with the gateway 528 via one or more other aerial devices. For example, the aerial device 522 and a second aerial device (not shown) may be part of a constellation of satellites (e.g., aerial devices) that communicate via inter-satellite links (ISLs). For example, the aerial device 522 may establish an ISL with the second aerial device. The ISL may be a radio interface or an optical interface and operate in the RF frequency or optical bands, respectively. The second aerial device may communicate with the gateway 528 via a second feeder link, similarly as the aerial device 522 communicates with the gateway 528.

In some examples, the aerial device 522 and/or the second aerial device may include an aerial device, such as, but not limited to, an unmanned aircraft system (UAS), a balloon, a drone, an unmanned aerial vehicle (UAV), or the like. Examples of a UAS platform that may be used for NTN communication include systems including Tethered UAS (TUA), Lighter Than Air UAS (LTA), Heavier Than Air UAS (HTA), and High Altitude Platforms (HAPs). In some examples, the aerial device 522 and/or the second aerial device may include a satellite or a space-borne vehicle placed into Low-Earth Orbit (LEO), Medium-Earth Orbit (MEO), Geostationary Earth Orbit (GEO), or High Elliptical Orbit (HEO).

In some aspects, the aerial device 522 and/or the second aerial device may implement a transparent payload (sometimes referred to as a “bent pipe” payload). For example, after receiving a signal, a transparent aerial device may have the ability to change the frequency carrier of the signal, perform RF filtering on the signal, and amplify the signal before outputting the signal. In such aspects, the signal output by the transparent aerial device may be a repeated signal in which the waveform of the output signal is unchanged relative to the received signal.

In other aspects, the aerial device 522 and/or the second aerial device may implement a regenerative payload. For example, a regenerative aerial device may have the ability to perform all of or part of the base station functions, such as transforming and amplifying a received signal via on-board processing before outputting a signal. In some such aspects, transformation of the received signal may refer to digital processing that may include demodulation, decoding, switching and/or routing, re-encoding, re-modulation, and/or filtering of the received signal.

In examples in which the aerial device implements a transparent payload, the transparent aerial device may communicate with the base station 502 via the gateway 528. In some such examples, the base station 502 may facilitate communication between the gateway 528 and the network node 506. In examples in which the aerial device implements a regenerative payload, the regenerative aerial device may have an on-board base station. In some such examples, the on-board base station may communicate with the network node 506 via the gateway 528. In some examples, the on-board base station may include a DU and a CU, such as the DU 105 and the CU 106 of FIG. 1. In some examples, the on-board base station may include a DU that is in communication with a corresponding CU that is on the ground.

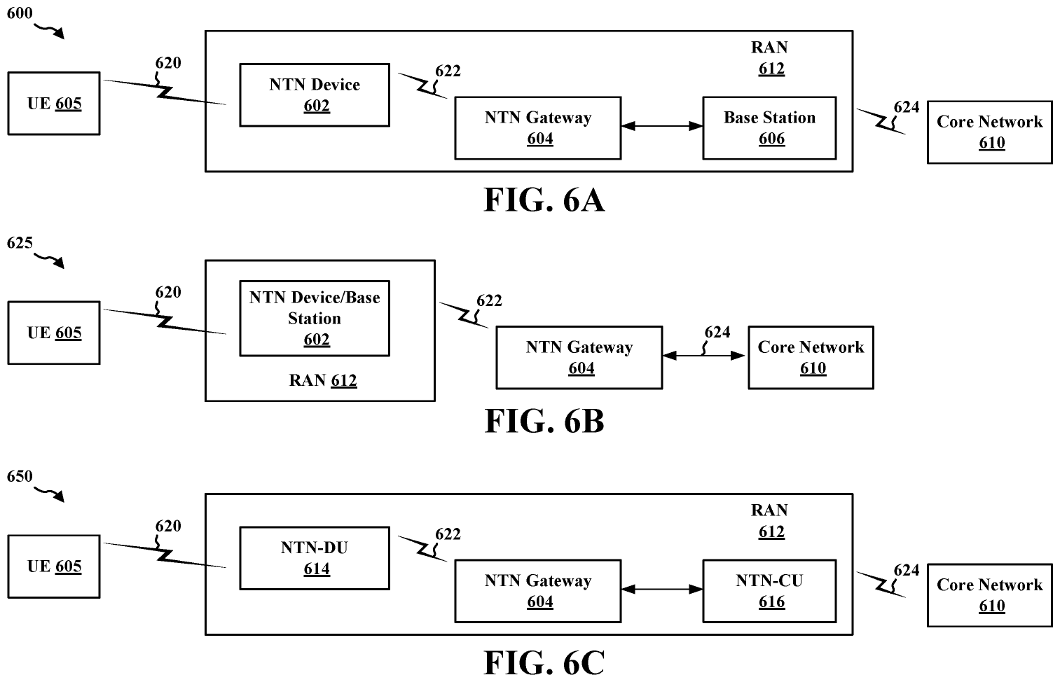

FIG. 6A illustrates an example network architecture 600 capable of supporting NTN access, e.g., using 5G NR, as presented herein. Although the aspects are described using the example of 5G NR, the concepts presented herein may also be applied for other types of core networks. FIG. 6A illustrates a network architecture with transparent payloads. While aspects of FIG. 6A illustrate a 5G-based network, similar network implementations and configurations may be used for other communication technologies, such as 3G, 4G LTE, etc.

The network architecture 600 of FIG. 6A includes a UE 605, an NTN device 602, an NTN gateway 604 (sometimes referred to as “gateways,” “earth stations,” or “ground stations”), and a base station 606 having the capability to communicate with the UE 605 via the NTN device 602. The NTN device 602, the NTN gateway 604, and the base station 606 may be part of a RAN 612 (e.g., an NG RAN).

The base station 606 may be a network node that corresponds to the base station 410 of FIG. 4. The network architecture 600 is illustrated as further including a core network 610. In some aspects, the core network 610 may include a number of Fifth Generation (5G) networks including 5G Core Networks (5GCNs) and may correspond to the core network 190 described in connection with FIG. 1. The core network 610 may be public land mobile networks (PLMN). In some aspects, the core network may be 5GCNs.

Permitted connections in the network architecture 600 with transparent payloads illustrated in FIG. 6A, allow the base station 606 to access the NTN gateway 604 and the core network 610. In some examples, the base station 606 may be shared by multiple PLMNs. Similarly, the NTN gateway 604 may be shared by more than one base station.

FIG. 6A provides a generalized illustration of various components, any or all of which may be utilized as appropriate, and each of which may be duplicated or omitted, as necessary. Specifically, although the example of FIG. 6A includes one UE 605, it should be understood that many UEs (e.g., hundreds, thousands, millions, etc.) may utilize the network architecture 600. Similarly, the network architecture 600 may include a larger (or smaller) number of NTN devices, NTN gateways, base stations, RAN, core networks, and/or other components. The illustrated connections that connect the various components in the network architecture 600 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 605 is configured to communicate with the core network 610 via the NTN device 602, the NTN gateway 604, and the base station 606. As illustrated by the RAN 612, one or more RANs associated with the core network 610 may include one or more base stations. Access to the network may be provided to the UE 605 via wireless communication between the UE 605 and the base station 606 (e.g., a serving base station), via the NTN device 602 and the NTN gateway 604. The base station 606 may provide wireless communications access to the core network 610 on behalf of the UE 605, e.g., using 5G NR.

The base station 606 may be referred to by other names such as a gNB, a “satellite node”, a satellite NodeB (sNB), “satellite access node”, etc. The base station 606 may not be the same as terrestrial network gNBs, but may be based on a terrestrial network gNB with additional capability. For example, the base station 606 may terminate the radio interface and associated radio interface protocols to the UE 605 and may transmit DL signals to the UE 605 and receive UL signals from the UE 605 via the NTN device 602 and the NTN gateway 604. The base station 606 may also support signaling connections and voice and data bearers to the UE 605 and may support handover of the UE 605 between different radio cells for the NTN device 602, between different NTN devices and/or between different base stations. The base station 606 may be configured to manage moving radio beams (e.g., for airborne vehicles and/or non-geostationary (non-GEO) devices) and associated mobility of the UE 605. The base station 606 may assist in the handover (or transfer) of the NTN device 602 between different NTN gateways or different base stations. In some examples, the base station 606 may be separate from the NTN gateway 604, e.g., as illustrated in the example of FIG. 6A. In other examples, the base station 606 may include or may be combined with one or more NTN gateways, e.g., using a split architecture. For example, with a split architecture, the base station 606 may include a Central Unit (CU), such as the example CU 106 of FIG. 1, and the NTN gateway 604 may include or act as Distributed Unit (DU), such as the example DU 105 of FIG. 1. The base station 606 may be fixed on the ground with transparent payload operation. In one implementation, the base station 606 may be physically combined with, or physically connected to, the NTN gateway 604 to reduce complexity and cost.

The NTN gateway 604 may be shared by more than one base station and may communicate with the UE 605 via the NTN device 602. The NTN gateway 604 may be dedicated to one associated constellation of NTN devices. The NTN gateway 604 may be included within the base station 606, e.g., as a base station-DU within the base station 606. The NTN gateway 604 may communicate with the NTN device 602 using control and user plane protocols. The control and user plane protocols between the NTN gateway 604 and the NTN device 602 may: (i) establish and release the NTN gateway 604 to the NTN device 602 communication links, including authentication and ciphering; (ii) update NTN device software and firmware; (iii) perform NTN device Operations and Maintenance (O&M); (iv) control radio beams (e.g., direction, power, on/off status) and mapping between radio beams and NTN gateway UL and DL payload; and/or (v) assist with handoff of the NTN device 602 or radio cell to another NTN gateway.

Support of transparent payloads with the network architecture 600 shown in FIG. 6A may impact the communication system as follows. The core network 610 may treat a satellite RAT as a new type of RAT with longer delay, reduced bandwidth and/or higher error rate. Consequently, there may be some impact to PDU session establishment and mobility management (MM) and connection management (CM) procedures. The NTN device 602 may be shared with other services (e.g., satellite television, fixed Internet access) with 5G NR mobile access for UEs added in a transparent manner. This may enable legacy NTN devices to be used and may avoid the need to deploy a new type of NTN device. The base station 606 may assist assignment and transfer of the NTN device 602 and radio cells between the base station 606 and the NTN gateway 604 and support handover of the UE 605 between radio cells, NTN devices, and other base stations. Thus, the base station 606 may differ from a terrestrial network gNB. Additionally, a coverage area of the base station 606 may be much larger than the coverage area of a terrestrial network base station.

In the illustrated example of FIG. 6A, a service link 620 may facilitate communication between the UE 605 and the NTN device 602, a feeder link 622 may facilitate communication between the NTN device 602 and the NTN gateway 604, and an interface 624 may facilitate communication between the base station 606 and the core network 610. The service link 620 and the feeder link 622 may be implemented by a same radio interface (e.g., the NR-Uu interface). The interface 624 may be implemented by the NG interface.

FIG. 6B shows a diagram of a network architecture 625 capable of supporting NTN access, e.g., using 5G NR, as presented herein. The network architecture 625 shown in FIG. 6B is similar to that shown in FIG. 6A, like designated elements being similar or the same. FIG. 6B, however, illustrates a network architecture with regenerative payloads, as opposed to transparent payloads shown in FIG. 6A. A regenerative payload, unlike a transparent payload, includes an on-board base station (e.g., includes the functional capability of a base station), and is referred to herein as an NTN device 602/base station. The on-board base station may be a network node that corresponds to the base station 410 in FIG. 4. The RAN 612 is illustrated as including the NTN device 602/base station. Reference to the NTN device 602/base station may refer to functions related to communication with the UE 605 and the core network 610 and/or to functions related to communication with the NTN gateway 604 and with the UE 605 at a physical radio frequency level.

An on-board base station may perform many of the same functions as the base station 606 as described previously. For example, the NTN device 602/base station may terminate the radio interface and associated radio interface protocols to the UE 605 and may transmit DL signals to the UE 605 and receive UL signals from the UE 605, which may include encoding and modulation of transmitted signals and demodulation and decoding of received signals. The NTN device 602/base station may also support signaling connections and voice and data bearers to the UE 605 and may support handover of the UE 605 between different radio cells for the NTN device 602/base station and between or among different NTN device/base stations. The NTN device 602/base station may assist in the handover (or transfer) of the UE 605 between different NTN gateways and different control networks. The NTN device 602/base station may hide or obscure specific aspects of the NTN device 602/base station from the core network 610, e.g., by interfacing to the core network 610 in the same way or in a similar way to a terrestrial network base station. The NTN device 602/base station may further assist in sharing of the NTN device 602/base station. The NTN device 602/base station may communicate with one or more NTN gateways and with one or more core networks via the NTN gateway 604. In some aspects, the NTN device 602/base station may communicate directly with other NTN device/base stations using Inter-Satellite Links (ISLs), which may support an Xn interface between any pair of NTN device/base stations.

With low Earth orbit (LEO) devices, the NTN device 602/base station may manage moving radio cells with coverage at different times. The NTN gateway 604 may be connected directly to the core network 610, as illustrated. The NTN gateway 604 may be shared by multiple core networks, for example, if NTN gateways are limited. In some examples the core network 610 may be aware of coverage area(s) of the NTN device 602/base station in order to page the UE 605 and to manage handover. Thus, as can be seen, the network architecture 625 with regenerative payloads may have more impact and complexity with respect to both the NTN device 602/base station and the core network 610 than the network architecture 600 including transparent payloads, as shown in FIG. 6A.

Support of regenerative payloads with the network architecture 625 shown in FIG. 6B may impact the network architecture 625 as follows. The core network 610 may be impacted if fixed tracking areas and fixed cells are not supported, because core components of mobility management and regulatory services, which are based on fixed cells and fixed tracking areas for terrestrial PLMNs, may be replaced by a new system (e.g., based on a location of the UE 605). If fixed tracking areas and fixed cells are supported, the core network 610 may map any fixed tracking area to one or more NTN device/base stations with current radio coverage of the fixed tracking area when performing paging of the UE 605 that is located in this fixed tracking area. This could include configuration in the core network 610 of long term orbital data for the NTN device 602/base station (e.g., obtained from an operator of the NTN device 602/base station) and could add significant new impact to core network 610.

In the illustrated example of FIG. 6B, a service link 620 may facilitate communication between the UE 605 and the NTN device 602/base station, a feeder link 622 may facilitate communication between the NTN device 602/base station and the NTN gateway 604, and an interface 624 may facilitate communication between the NTN gateway 604 and the core network 610. The service link 620 may be implemented by the NR-Uu interface. The feeder link 622 may be implemented by the NG interface over SRI. The interface 624 may be implemented by the NG interface.

FIG. 6C shows a diagram of a network architecture 650 capable of supporting NTN access, e.g., using 6G NR, as presented herein. The network architecture shown in FIG. 6C is similar to that shown in FIGS. 6A and 6B, like designated elements being similar or the same. FIG. 6C, however, illustrates a network architecture with regenerative payloads, as opposed to transparent payloads, as shown in FIG. 6A, and with a split architecture for the base station. For example, the base station may be split between a Central Unit (CU), such as the CU 106 of FIG. 1, and a Distributed Unit (DU), such as the DU 105 of FIG. 1. In the illustrated example of FIG. 6C, the network architecture 650 includes an NTN-CU 616, which may be a ground-based base station or a terrestrial base station. The regenerative payloads include an on-board base station DU, and is referred to herein as an NTN-DU 614. The NTN-CU 616 and the NTN-DU 614, collectively or individually, may correspond to the network node associated with the base station 410 in FIG. 4.

The NTN-DU 614 communicates with the NTN-CU 616 via the NTN gateway 604. The NTN-CU 616 together with the NTN-DU 614 perform functions, and may use internal communication protocols, which are similar to or the same as a gNB with a split architecture. In the example, the NTN-DU 614 may correspond to and perform functions similar to or the same as a gNB Distributed Unit (gNB-DU), while the NTN-CU 616 may correspond to and perform functions similar to or the same as a gNB Central Unit (gNB-CU). However, the NTN-CU 616 and the NTN-DU 614 may each include additional capability to support the UE 605 access using NTN devices.

The NTN-DU 614 and the NTN-CU 616 may communicate with one another using an F1 Application Protocol (F1AP), and together may perform some or all of the same functions as the base station 606 or the NTN device 602/base station as described in connection with FIGS. 6B and 6C, respectively.

The NTN-DU 614 may terminate the radio interface and associated lower level radio interface protocols to the UE 605 and may transmit DL signals to the UE 605 and receive UL signals from the UE 605, which may include encoding and modulation of transmitted signals and demodulation and decoding of received signals. The operation of the NTN-DU 614 may be partly controlled by the NTN-CU 616. The NTN-DU 614 may support one or more NR radio cells for the UE 605. The NTN-CU 616 may also be split into separate control plane (CP) (NTN-CU-CP) and user plane (UP) (NTN-CU-UP) portions. The NTN-DU 614 and the NTN-CU 616 may communicate over an F1 interface to (a) support control plane signaling for the UE 605 using IP, Stream Control Transmission Protocol (SCTP) and F1 Application Protocol (F1AP) protocols, and (b) to support user plane data transfer for a UE using IP, User Datagram Protocol (UDP), PDCP. SDAP, GTP-U and NR User Plane Protocol (NRUPP) protocols.

The NTN-CU 616 may communicate with one or more other NTN-CUs and/or with one more other terrestrial base stations using terrestrial links to support an Xn interface between any pair of NTN-CUs and/or between the NTN-CU 616 and any terrestrial base station.

The NTN-DU 614 together with the NTN-CU 616 may: (i) support signaling connections and voice and data bearers to the UE 605; (ii) support handover of the UE 605 between different radio cells for the NTN-DU 614 and between different NTN-DUs; and (iii) assist in the handover (or transfer) of NTN devices between different NTN gateways or different core networks. The NTN-CU 616 may hide or obscure specific aspects of the NTN devices from the core network 610, e.g., by interfacing to the core network 610 in the same way or in a similar way to a terrestrial network base station.

In the network architecture 650 of FIG. 6C, the NTN-DU 614 that communicates with and is accessible from an NTN-CU may change over time with LEO devices. With the split base station architecture, the core network 610 may connect to NTN-CUs that are fixed and that do not change over time, which may reduce difficulty with paging of the UE 605. For example, the core network 610 may not need to know which NTN-DU is needed for paging the UE 605. The network architecture with regenerative payloads with a split base station architecture may thereby reduce the core network 610 impact at the expense of additional impact to the NTN-CU 616.

Support of regenerative payloads with a split base station architecture, as shown in FIG. 6C, may impact the network architecture 650 as follows. The impact to the core network 610 may be limited as for the transparent payloads (e.g., the NTN device 602) discussed above. For example, the core network 610 may treat a satellite RAT in the network architecture 650 as a new type of RAT with longer delay, reduced bandwidth and/or higher error rate. The impact on the NTN-DU 614 may be less than the impact on NTN device/base stations (e.g., the NTN device 602/base station with a non-split architecture), as discussed above in reference to FIG. 6B. The NTN-DU 614 may manage changing association with different (fixed) NTN-CUs. Further, the NTN-DU 614 may manage radio beams and radio cells. The NTN-CU 616 impacts may be similar to the impact of the base station 606 for a network architecture with transparent payloads, as discussed above, except for extra impacts to manage changing associations with different NTN-DUs and reduced impacts to support radio cells and radio beams, which may be transferred to the NTN-DU 614.

There are several operations where a UE that is connected to a NTN may prefer to utilize a TN as a preferred mode for certain operations or applications, such as but not limited to, voice calls (e.g., voice over NR), robotic-assisted surgery, online classes, video calls, low latency applications, real-time applications, or the like. Due to latency or real-time constraint, satellite connectivity may introduce additional propagation delay which may negatively impact the latency or real-time constraint, which may impact the user experience. Aspects presented herein provide smart handling of UEs by the network in a mixed deployment configuration.

Aspects presented herein provide a configuration for optimizing operations between TNs and NTNs. The aspects presented herein may enable a UE to provide a network preference of a second network based on an application at the UE. For example, a UE connected to first network may transmit, to the first network, an indication of the network preference for the second network based on at least one application at the UE.

In some instances, there may be multiple places where both TN and NTN connectivity is available, which may be configured to share the data or traffic load, especially in the busy hours for that area/location. In such instances, the load balancing between TN and NTN may be based on certain UEs or device factors, in order to optimize the UE experience.

The UE may be configured to indicate to its serving network regarding a preference for TN or NTN based on user applications at the UE. The preference for TN or NTN may comprise a request to switch to another network other than the serving network. This request may be initiated based on a UE assistance message. In some instances, an information element (IE) may comprise this request for the preference for TN or NTN as per the UE request based on at least one condition/application at the UE. In some instances, the request for the preference for TN or NTN may comprise a minimum time duration for the network preference. For example, the minimum time duration may include a period of time that the UE may operate the application on the preferred network.

The UE transmitting the indication regarding the preference for TN or NTN may inform the current serving network to know whether the UE is in a TN mode or a NTN mode at a given time, which may help to optimize the load balancing between the NTN and TN, which may further ensure an optimized UE operation. However, the network may be indicated about the preference in order to take the optimal decision for the UE placement or transition on a cell associated with TN or NTN. In such instances, if the UE is in the TN mode (e.g., more real-time applications at the UE), then the network may decide the mobility based on the request and will provide the UE with an indication to transition to a TN cell as best possible, otherwise the network may decide to move the device to a TN node as per the minimum signal strength and availability as a forced handover. In some instances, the UE may switch or transition to the TN mode or the NTN mode automatically based at least on other artificial intelligence (AI)/machine learning (ML) based applications to detect if the UE is in a dense region or a region where no coverage is detected.

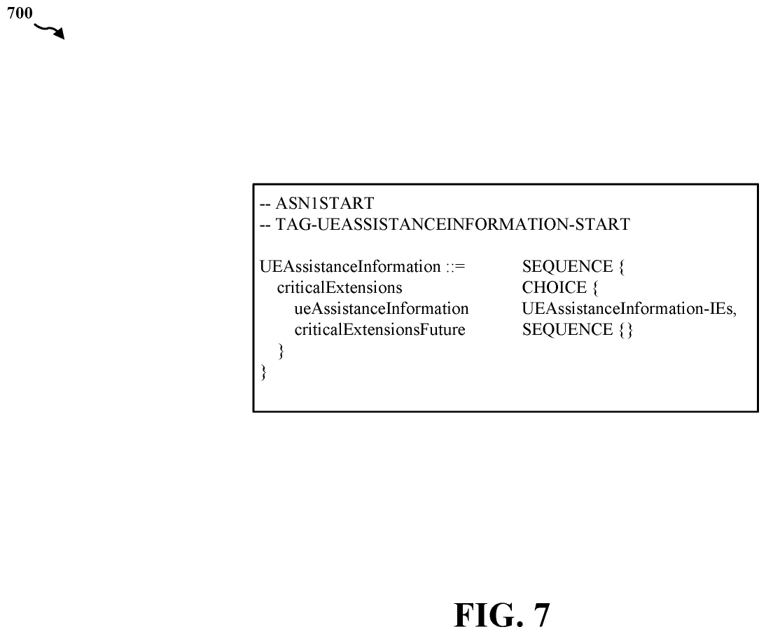

FIG. 7 provides a diagram 700 of an example of a UE assistance information message. The UE assistance information message may be used for the indication of UE assistance information to the network. In some aspects, the signaling radio bearer (SRB) may comprise SRB1, SRB3. In some aspects, the radio link control (RLC) service access point (SAP) (RLC-SAP) may comprise acknowledged mode (AM). In some aspects, the logical channel may comprise a dedicated control channel (DCCH). The direction of transmission of the UE assistance information message may be in the direction of UE to the network.

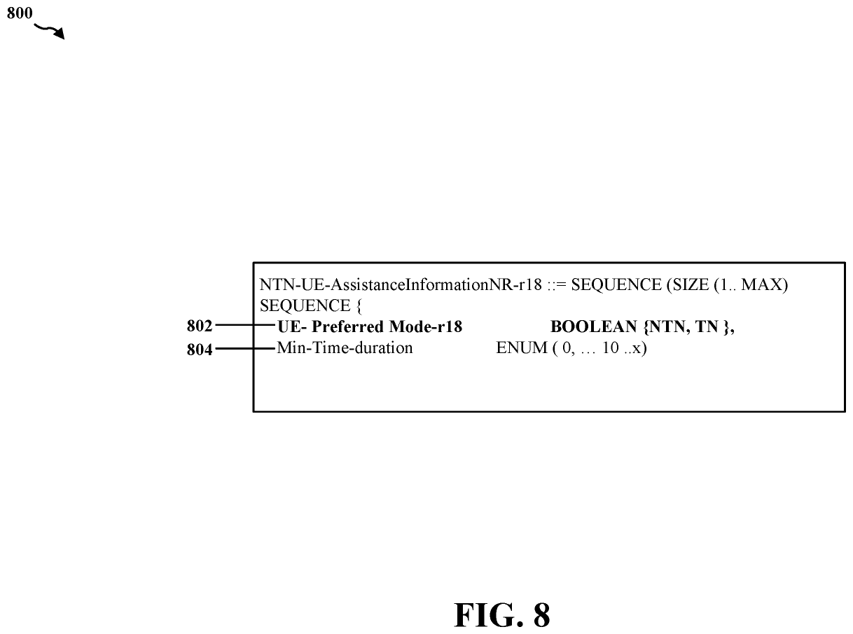

FIG. 8 provides a diagram 800 of an example of an NTN UE assistance information message. The NTN UE assistance information message may comprise a UE preferred mode 802 (e.g., UE-Preferred Mode-r18) which indicates a preference for a TN or NTN. The NTN UE assistance information message may comprise a minimum time duration 804 (e.g., Min-Tim-duration) which may indicate a duration (e.g., period of time or symbols) for use of the preferred network. For example, the minimum time duration 804 may include a time duration that the UE plans on operating the application on the preferred network. In some instances, if a UE is in a NTN or TN network, the device may provide an indication or preference for a NTN cell based on network measurement and mobility, but as per the application running on the UE, UE may prefer to be in a TN mode for a specific period of time or duration. In such instances, the UE may request for the TN mode preference for such specific period of time or duration. The decision may be decided by the network as to the best possible outcome. For example, the network may determine to transition the UE to the TN mode, or the network may reject the request for the preferred network. The network may accept or reject the request upon an expiration of a time. In such instances, the UE preferred mode may be deleted from the network database.

In some instances, if the UE is in a TN mode (e.g., more of real-time applications), then the network may decide the mobility based on the network preference request. The network may provide an indication to the UE to move or transition to a TN cell. In some instances, the network may decide to move the UE to a TN node as per the minimum signal strength and availability as a forced handover.

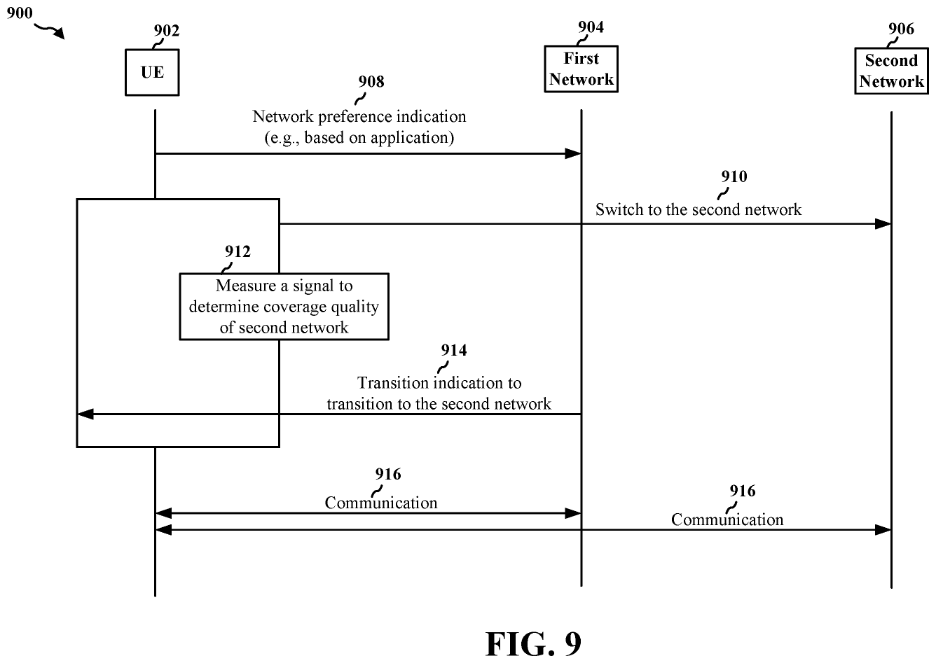

FIG. 9 is a call flow diagram 900 of signaling between a UE 902, a first base station associated with a first network 904, and a second base station associated with a second network 906. The first base station associated with the first network 904 may be configured to provide at least one cell, and the second base station associated with the second network 906 may be configured to provide at least one cell. The UE 902 may be configured to communicate with the first network 904 or the second network 906. For example, in the context of FIG. 1, the first base station associated with the first network 904 or the second base station associated with the second network 906, may correspond to base station 102, and the UE 902 may correspond to at least UE 104. In another example, in the context of FIG. 4, the first base station associated with the first network 904 or the second base station associated with the second network 906 may correspond to base station 410 and the UE 902 may correspond to UE 450.

At 908, the UE 902 may transmit an indication of a network preference for a second network 906 based on at least an application at the UE. The UE 902 may transmit the indication of the network preference for the second network 906 to the first network 904 connected to the UE. As an example, the first network 904 may be an NTN, and the UE 902 may indicate a preference for a TN (e.g., the second network 906). In another example, the first network 904 may be a TN, and the UE 902 may indicate a preference for an NTN (e.g., the second network 906). The TN and NTN may include any of the aspects described in connection with FIG. 1, 2, 5, or 6A-6C. The indication may include any of the aspects described in connection with FIG. 7 or FIG. 8. In some aspects, the indication may be comprised in a UE assistance message to the first network. In some aspects, the indication may indicate a time duration associated with the network preference for the application at the UE. For example, the indication may provide a period of time for which the UE may operate or run the application, such that the UE may prefer to operate or run the application on the preferred network (e.g., second network 906). In some aspects, the application at the UE comprises a throughput limitation or request that is provided by the preferred network (e.g., second network). For example, the application may have throughput conditions that may be provided or satisfied by the preferred network (e.g., second network), that may or may not be available at the first network.

In some aspects, for example at 910, the UE 902 may switch to the second network 906 automatically. The UE may switch to the second network automatically in response to transmission of the indication of the network preference to the first network. In such instances, the UE may switch from the first network, which is currently serving the UE, to the second network in response to transmitting the indication of the network preference for the second network. The UE may switch or establish a connection with the second network 906, from the first network 904, autonomously or without express instructions or authorization from the first network 904.

In some aspects, for example at 912, the UE 902 may measure a signal corresponding to the second network 906. The UE may measure the signal corresponding to the second network to determine a coverage quality of the second network. For example, the UE may determine the coverage quality of the second network to determine a cell associated with the second network having the highest signal strength or having a signal strength that exceeds a threshold. In such instances, the UE may establish a connection with the cell associated with the second network having the highest signal strength or having the signal strength that exceeds the threshold.

In some aspects, for example at 914, the first network 904 may provide a transition indication instructing the UE 902 to transition to a cell associated with the second network 906. The first network 904 may provide the transition indication, to the UE 902, instructing the UE 902 to transition to a cell associated with the second network 906. The UE 902 may receive the transition indication, from the first network 904, instructing the UE 902 to transition to a cell associated with the second network 906. The first base station associated with the first network may provide the transition indication instructing the UE to transition to the cell associated with the second network in response to the first indication. In some aspects, the first network may comprise a NTN serving the UE, and the indication of the network preference indicates a preference for a TN, where the second network comprises the TN.

At 916, the UE 902 may communicate with at least one of the first network 904 or the second network 906. The UE 902 may communicate with at least one of the first network 904 or the second network 906 based on transmission of the indication of the network preference for the second network.

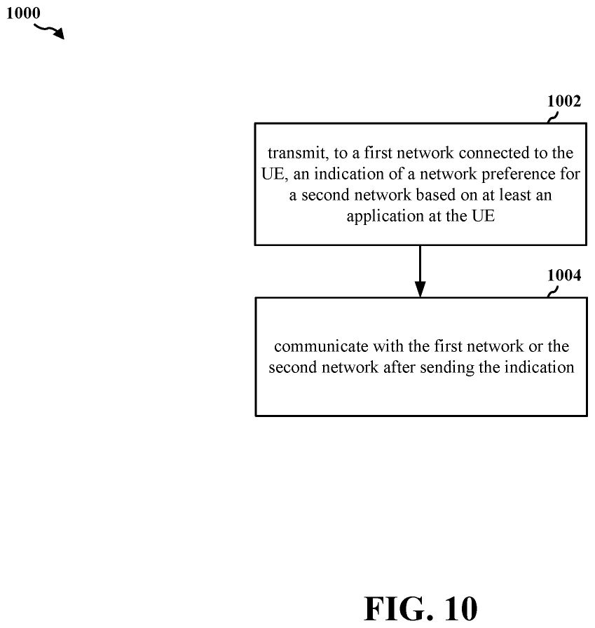

FIG. 10 is a flowchart 1000 of a method of wireless communication. The method may be performed by a UE (e.g., the UE 104; the UE 902; the apparatus 1204). One or more of the illustrated operations may be omitted, transposed, or contemporaneous. The method may allow a UE to transmit an indication of a network preference based on at least an application at the UE.

At 1002, the UE may transmit an indication of a network preference for a second network based on at least an application at the UE. For example, 1002 may be performed by indication component 198 of apparatus 1204. The UE may transmit the indication of the network preference for the second network to a first network connected to the UE. In some aspects, the indication may be comprised in a UE assistance message to the first network. In some aspects, the indication may indicate a time duration associated with the network preference for the application at the UE. For example, the indication may provide a period of time for which the UE may operate or run the application, such that the UE may prefer to operate or run the application on the preferred network. In some aspects, the application at the UE comprises a throughput limitation that is provided by the second network. For example, the application may have throughput conditions that may be provided or satisfied by the second network, that may or may not be available at the first network. The indication may include any of the aspects described in connection with FIGS. 7-9, for example. The first network and the second network may include a TN and an NTN. e.g., as described in connection with any of FIG. 5, 6A-6C, or 9.

At 1004, the UE may communicate with the first network or the second network after sending the indication. For example, 1004 may be performed by indication component 198 of apparatus 1204. In some aspects, the first network is a non-terrestrial network (NTN) serving the UE, and the indication indicates a preference for a terrestrial network (TN), where the second network comprises the TN. In some aspects, the indication may indicate the network preference for the second network based on a condition at the UE. For example, the condition at the UE may be based on at least one of throughput conditions of the application or a time duration for usage of the application.

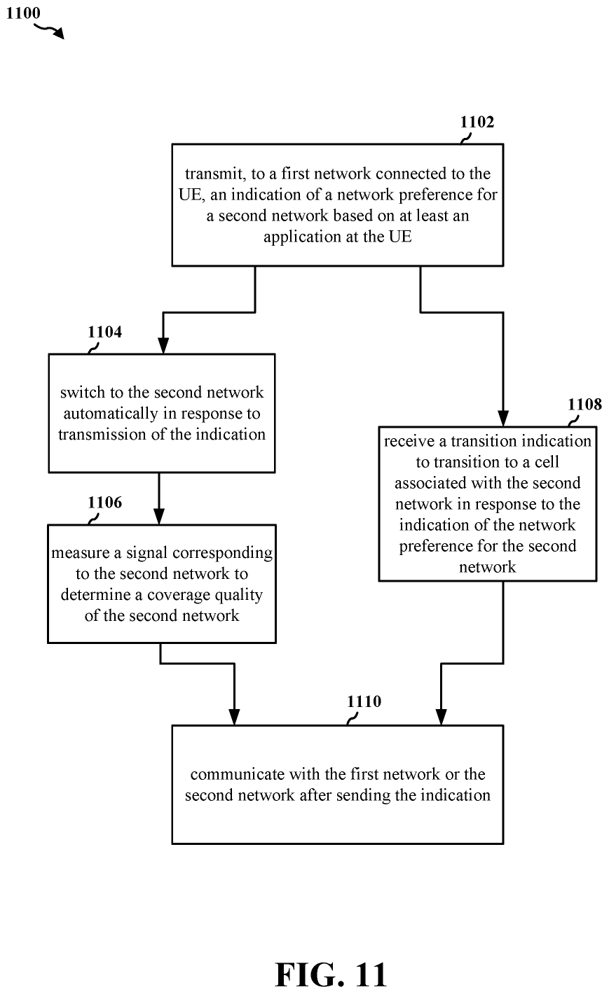

FIG. 11 is a flowchart 1100 of a method of wireless communication. The method may be performed by a UE (e.g., the UE 104; the UE 902; the apparatus 1204). One or more of the illustrated operations may be omitted, transposed, or contemporaneous. The method may allow a UE to transmit an indication of a network preference based on at least an application at the UE.

At 1102, the UE may transmit an indication of a network preference for a second network based on at least an application at the UE. For example, 1102 may be performed by indication component 198 of apparatus 1204. The UE may transmit the indication of the network preference for the second network to a first network connected to the UE. In some aspects, the indication may be comprised in a UE assistance message to the first network. In some aspects, the indication may indicate a time duration associated with the network preference for the application at the UE. For example, the indication may provide a period of time for which the UE may operate or run the application, such that the UE may prefer to operate or run the application on the preferred network. In some aspects, the application at the UE comprises a throughput limitation that is provided by the second network. For example, the application may have throughput conditions that may be provided or satisfied by the second network, that may or may not be available at the first network. The indication may include any of the aspects described in connection with FIGS. 7-9, for example. The first network and the second network may include a TN and an NTN, e.g., as described in connection with any of FIG. 5, 6A-6C, or 9.

At 1104, the UE may switch to the second network automatically. For example, 1104 may be performed by indication component 198 of apparatus 1204. The UE may switch to the second network automatically in response to transmission of the indication of the network preference to the first network. In such instances, the UE may switch from the first network, which is currently serving the UE, to the second network in response to transmitting the indication of the network preference for the second network.

At 1106, the UE may measure a signal corresponding to the second network. For example, 1106 may be performed by indication component 198 of apparatus 1204. The UE may measure the signal corresponding to the second network to determine a coverage quality of the second network. For example, the UE may determine the coverage quality of the second network to determine a cell associated with the second network having the highest signal strength or having a signal strength that exceeds a threshold.

At 1108, the UE may receive a transition indication for the UE to transition to a cell associated with the second network. For example, 1108 may be performed by indication component 198 of apparatus 1204. The UE may receive the transition indication for the UE to transition to the cell associated with the second network from the first network, which is serving the UE. The UE may receive the transition indication for the UE to transition to the cell associated with the second network from the first network in response to the indication of the network preference for the second network.

At 1110, the UE may communicate with the first network or the second network after sending the indication. For example, 1110 may be performed by indication component 198 of apparatus 1204. In some aspects, the first network is a NTN serving the UE, and the indication indicates a preference for a TN, where the second network comprises the TN. In some aspects, the indication may indicate the network preference for the second network based on a condition at the UE. For example, the condition at the UE may be based on at least one of throughput conditions of the application or a time duration for usage of the application.

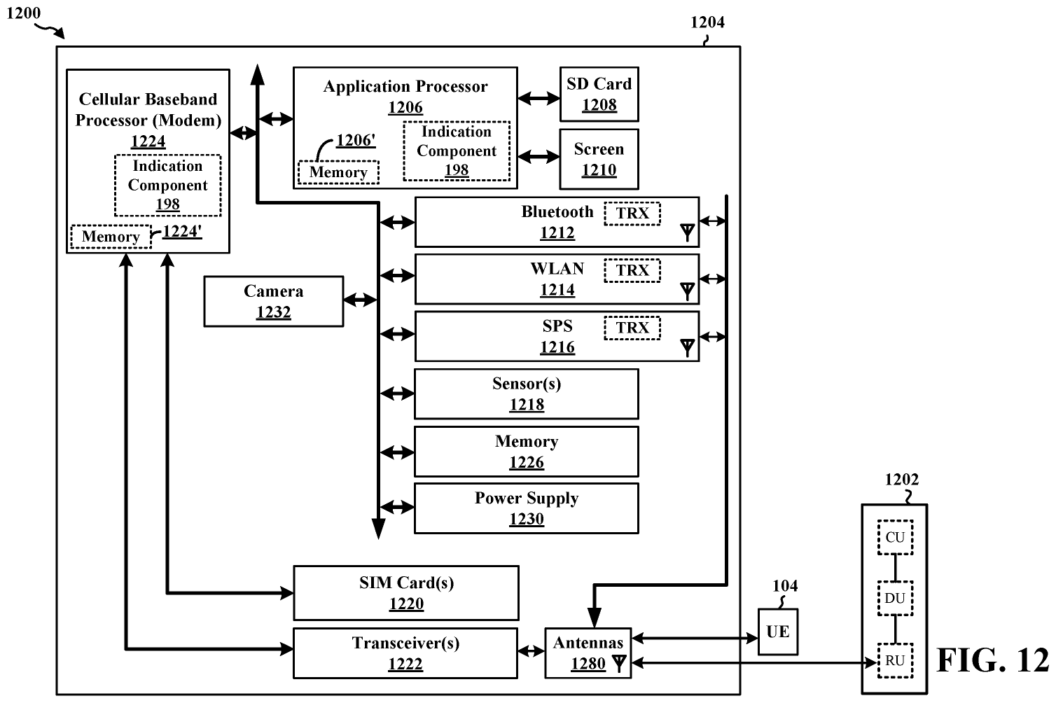

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 450 and may include the memory 460 and/or at least one of the TX processor 468, the RX processor 456, and the controller/processor 459. In one configuration, the apparatus 1204 may be a processor chip (modem and/or application) and include just the cellular baseband processor 1224 and/or the application processor 1206, and in another configuration, the apparatus 1204 may be the entire UE (e.g., see 450 of FIG. 4) and include the additional modules of the apparatus 1204.

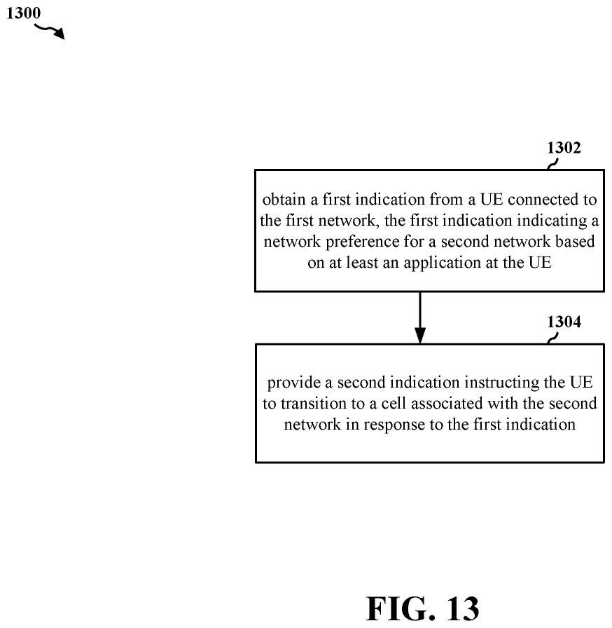

As discussed supra, the component 198 is configured to transmit, to a first network connected to the UE, an indication of a network preference for a second network based on at least an application at the UE; and communicate with the first network or the second network after sending the indication. The component 198 may be further configured to perform any of the aspects described in connection with FIG. 10 or FIG. 11, and/or any of the aspects performed by the UE in the communication flow in FIG. 9. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for transmitting, to a first network connected to the UE, an indication of a network preference for a second network based on at least an application at the UE. The apparatus includes means for communicating with the first network or the second network after sending the indication. The apparatus further includes means for switching to the second network automatically in response to transmission of the indication. The apparatus further includes means for measuring a signal corresponding to the second network to determine a coverage quality of the second network. The apparatus further includes means for receiving a transition indication for the UE to transition to a cell associated with the second network in response to the indication of the network preference for the second network. The apparatus may further include means for performing any of the aspects described in connection with FIG. 10 or FIG. 11, and/or any of the aspects performed by the UE in the communication flow in FIG. 9. The means may be the component 198 of the apparatus 1204 configured to perform the functions recited by the means. As described supra, the apparatus 1204 may include the TX processor 468, the RX processor 456, and the controller/processor 459. As such, in one configuration, the means may be the TX processor 468, the RX processor 456, and/or the controller/processor 459 configured to perform the functions recited by the means. FIG. 13 is a flowchart 1300 of a method of wireless communication. The method may be performed by a base station associated with a first network (e.g., the base station 102; the first network 904; the network entity 1402). One or more of the illustrated operations may be omitted, transposed, or contemporaneous. The method may allow a UE to transition to a second network, from the first network, in response to an indication of a network preference based on at least an application at the UE.

At 1302, the network entity associated with the first network may obtaining a first indication from a UE connected to the first network. For example, 1302 may be performed by indication component 199 of network entity 1402. The first indication indicating a network preference for a second network based on at least an application at the UE. In some aspects, the first indication may be comprised in a UE assistance message to the first network. In some aspects, the UE assistance message comprises a time duration associated with the network preference for the application at the UE. For example, the indication may provide a period of time for which the UE may operate or run the application, such that the UE may prefer to operate or run the application on the preferred network. In some aspects, the application at the UE comprises a throughput limitation that is provided by the second network. For example, the application may have throughput conditions that may be provided or satisfied by the second network, that may or may not be available at the first network. In some aspects, the first indication may indicate the network preference for the second network based on a condition at the UE. For example, the condition at the UE may be based on at least one of throughput conditions of the application or a time duration for usage of the application. The indication may include any of the aspects described in connection with FIGS. 7-9, for example. The first network and the second network may include a TN and an NTN, e.g., as described in connection with any of FIG. 5, 6A-6C, or 9.

At 1304, the network entity associated with the first network may provide a second indication instructing the UE to transition to a cell associated with the second network. For example, 1304 may be performed by indication component 199 of network entity 1402. The network entity associated with the first network may provide the second indication instructing the UE to transition to the cell associated with the second network in response to the first indication. In some aspects, the first network is a NTN serving the UE, and the first indication indicates a preference for a TN, where the second network comprises the TN.

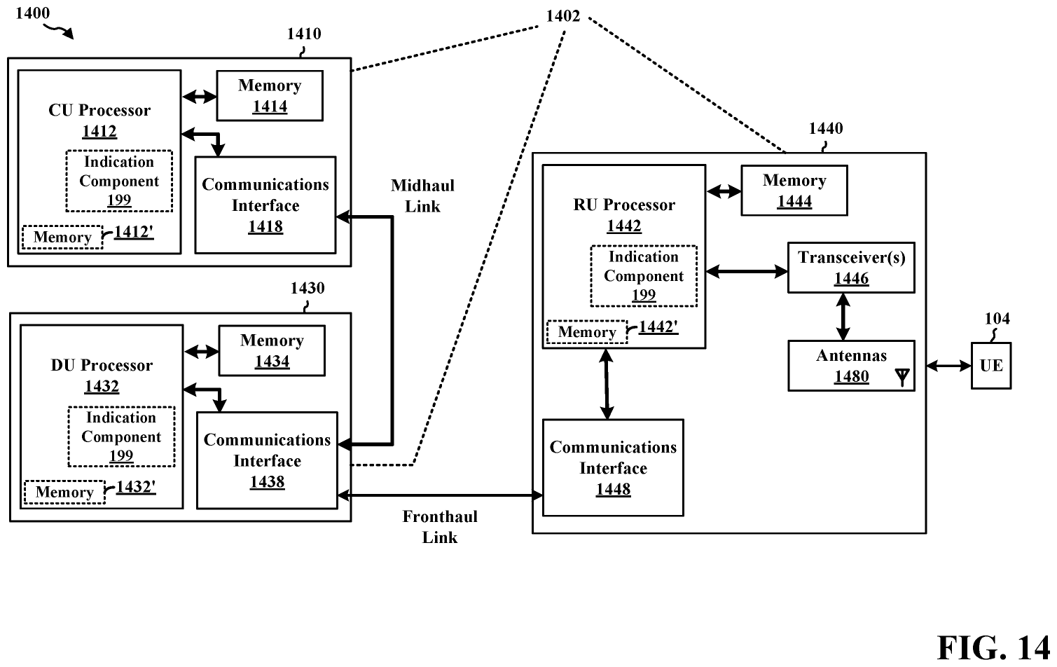

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′. 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to obtain a first indication from a UE connected to the first network, the first indication indicating a network preference for a second network based on at least an application at the UE; and provide a second indication instructing the UE to transition to a cell associated with the second network in response to the first indication. The component 199 may be further configured to perform any of the aspects described in connection with FIG. 1 and/or any of the aspects performed by the first network in the communication flow in FIG. 9. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for obtaining a first indication from a UE connected to the first network, the first indication indicating a network preference for a second network based on at least an application at the UE. The network entity includes means for providing a second indication instructing the UE to transition to a cell associated with the second network in response to the first indication. The network entity may further include means for performing any of the aspects described in connection with FIG. 1 and/or any of the aspects performed by the first network in the communication flow in FIG. 9. The means may be the component 199 of the network entity 1402 configured to perform the functions recited by the means. As described supra, the network entity 1402 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising transmitting, to a first network connected to the UE, an indication of a network preference for a second network based on at least an application at the UE; and communicating with the first network or the second network after sending the indication.

Aspect 2 is the method of aspect 1, further includes that the first network is a NTN serving the UE, and the indication indicates a preference for a TN, or wherein the first network is the TN serving the UE, and the indication indicates the preference for the NTN.

Aspect 3 is the method of any of aspects 1 and 2, further includes that the indication is comprised in a UE assistance message to the first network.

Aspect 4 is the method of any of aspects 1-3, further including switching to the second network automatically in response to transmission of the indication; and measuring a signal corresponding to the second network to determine a coverage quality of the second network.

Aspect 5 is the method of any of aspects 1-4, further includes that the indication further indicates a time duration associated with the network preference for the application at the UE.

Aspect 6 is the method of any of aspects 1-5, further includes that the application at the UE comprises a throughput limitation that is provided by the second network.

Aspect 7 is the method of any of aspects 1-6, further includes that the indication indicates the network preference for the second network based on a condition at the UE.

Aspect 8 is the method of any of aspects 1-7, further including receiving a transition indication for the UE to transition to a cell associated with the second network in response to the indication of the network preference for the second network.

Aspect 9 is an apparatus for wireless communication at a UE including at least one processor coupled to a memory and at least one transceiver, the at least one processor configured to implement any of Aspects 1-8.

Aspect 10 is an apparatus for wireless communication at a UE including means for implementing any of Aspects 1-8.

Aspect 11 is a computer-readable medium storing computer executable code, where the code when executed by a processor causes the processor to implement any of Aspects 1-8.

Aspect 12 is a method of wireless communication at a network entity associated with a first network comprising obtaining a first indication from a UE connected to the first network, the first indication indicating a network preference for a second network based on at least an application at the UE; and providing a second indication instructing the UE to transition to a cell associated with the second network in response to the first indication.

Aspect 13 is the method of aspect 12, further includes that the first network is a NTN serving the UE, and the first indication indicates a preference for a TN, or wherein the first network is the TN serving the UE, and the first indication indicates the preference for the NTN.

Aspect 14 is the method of any of aspects 12 and 13, further includes that the first indication is comprised in a UE assistance message to the first network.

Aspect 15 is the method of any of aspects 12-14, further includes that the UE assistance message comprises a time duration associated with the network preference for the application at the UE.

Aspect 16 is the method of any of aspects 12-15, further includes that the application at the UE comprises a throughput limitation that is provided by the second network.

Aspect 17 is the method of any of aspects 12-16, further includes that the first indication indicates the network preference for the second network based on a condition at the UE.

Aspect 18 is an apparatus for wireless communication at a network entity including at least one processor coupled to a memory and at least one transceiver, the at least one processor configured to implement any of Aspects 12-17.

Aspect 19 is an apparatus for wireless communication at a network entity including means for implementing any of Aspects 12-17.

Aspect 20 is a computer-readable medium storing computer executable code, where the code when executed by a processor causes the processor to implement any of Aspects 12-17.

What is claimed is:

1. An apparatus for wireless communication at a user equipment (UE), comprising:
a memory; and
at least one processor coupled to the memory and, based at least in part on information stored in the memory, the at least one processor is configured to:
transmit, to a first network connected to the UE, an indication of a network preference for a second network based on at least an application at the UE; and
communicate with the first network or the second network after sending the indication.

2. The apparatus of claim 1, further comprising a transceiver coupled to the at least one processor.

3. The apparatus of claim 1, wherein the first network is a non-terrestrial network (NTN) serving the UE, and the indication indicates a preference for a terrestrial network (TN), or wherein the first network is the TN serving the UE, and the indication indicates the preference for the NTN.

4. The apparatus of claim 1, wherein the indication is comprised in a UE assistance message to the first network.

5. The apparatus of claim 1, wherein the at least one processor is configured to:
switch to the second network automatically in response to transmission of the indication; and
measure a signal corresponding to the second network to determine a coverage quality of the second network.

6. The apparatus of claim 1, wherein the indication further indicates a time duration associated with the network preference for the application at the UE.

7. The apparatus of claim 1, wherein the application at the UE comprises a throughput limitation that is provided by the second network.

8. The apparatus of claim 1, wherein the indication indicates the network preference for the second network based on a condition at the UE.

9. The apparatus of claim 1, wherein the at least one processor is configured to:
receive a transition indication for the UE to transition to a cell associated with the second network in response to the indication of the network preference for the second network.

10. A method of wireless communication at a user equipment (UE), comprising:
transmitting, to a first network connected to the UE, an indication of a network preference for a second network based on at least an application at the UE; and
communicating with the first network or the second network after sending the indication.

11. The method of claim 10, wherein the first network is a non-terrestrial network (NTN) serving the UE, and the indication indicates a preference for a terrestrial network (TN), or wherein the first network is the TN serving the UE, and the indication indicates the preference for the NTN.

12. The method of claim 10, wherein the indication is comprised in a UE assistance message to the first network.

13. The method of claim 10, further comprising:
switching to the second network automatically in response to transmission of the indication; and
measuring a signal corresponding to the second network to determine a coverage quality of the second network.

14. The method of claim 10, wherein the indication further indicates a time duration associated with the network preference for the application at the UE.

15. The method of claim 10, wherein the application at the UE comprises a throughput limitation that is provided by the second network.

16. The method of claim 10, wherein the indication indicates the network preference for the second network based on a condition at the UE.

17. The method of claim 10, further comprising:
receiving a transition indication for the UE to transition to a cell associated with the second network in response to the indication of the network preference for the second network.

18. An apparatus for wireless communication at a network entity associated with a first network, comprising:
a memory; and
at least one processor coupled to the memory and, based at least in part on information stored in the memory, the at least one processor is configured to:
obtain a first indication from a user equipment (UE) connected to the first network, the first indication indicating a network preference for a second network based on at least an application at the UE; and
provide a second indication instructing the UE to transition to a cell associated with the second network in response to the first indication.

19. The apparatus of claim 18, further comprising a transceiver coupled to the at least one processor.

20. The apparatus of claim 18, wherein the first network is a non-terrestrial network (NTN) serving the UE, and the first indication indicates a preference for a terrestrial network (TN), or wherein the first network is the TN serving the UE, and the first indication indicates the preference for the NTN.

21. The apparatus of claim 18, wherein the first indication is comprised in a UE assistance message to the first network.

22. The apparatus of claim 21, wherein the UE assistance message comprises a time duration associated with the network preference for the application at the UE.

23. The apparatus of claim 18, wherein the application at the UE comprises a throughput limitation that is provided by the second network.

24. The apparatus of claim 18, wherein the first indication indicates the network preference for the second network based on a condition at the UE.

25. A method of wireless communication at a network entity associated with a first network, comprising:
obtaining a first indication from a user equipment (UE) connected to the first network, the first indication indicating a network preference for a second network based on at least an application at the UE; and
providing a second indication instructing the UE to transition to a cell associated with the second network in response to the first indication.

26. The method of claim 25, wherein the first network is a non-terrestrial network (NTN) serving the UE, and the first indication indicates a preference for a terrestrial network (TN), or wherein the first network is the TN serving the UE, and the first indication indicates the preference for the NTN.

27. The method of claim 25, wherein the first indication is comprised in a UE assistance message to the first network.

28. The method of claim 27, wherein the UE assistance message comprises a time duration associated with the network preference for the application at the UE.

29. The method of claim 25, wherein the application at the UE comprises a throughput limitation that is provided by the second network.

30. The method of claim 25, wherein the first indication indicates the network preference for the second network based on a condition at the UE.
